(19) United States
(12) Patent Application Publication
(10) Pub. No.: US 2017/0363018 A1
(43) Pub. Date: Dec. 21, 2017

(54) Valve device in a motor vehicle

(71) Applicant: CONTINENTAL AUTOMOTIVE GmbH, Hannover (DE)

(72) Inventors: Rainer Johannes MONTIGNY, Bad Soden (DE); Peter KOHLEN, Neu Anspach (DE); Stefan KOPP, Bruchkoebel (DE)

(21) Appl. No.: 15/537,169

(22) PCT Filed: Dec. 15, 2015
(86) PCT No.: PCT/EP2015/079760

§ 371 Date: Jun. 16, 2017

(30) Foreign Application Priority Data
Dec. 19, 2014 (DE) 10 2014 226 736.6

(51) Int. Cl. F02D 9/10; F16K 1/226; F16K 31/04; H01M 8/04

(52) U.S. Cl. CPC F02D 9/1025; H01M 8/04; F16K 1/2268; F16K 31/043

(57) ABSTRACT

A valve device for a fuel cell arrangement in a motor vehicle includes: a housing; a flow channel that extends in the housing; a spindle mounted rotatably in the housing; a flap fastened to the spindle, the flap being arranged in the flow channel and configured to close off the flow channel, the flap having a bore via which bore the spindle penetrates the flap; a drive configured to drive the flap via the spindle; a valve seat arranged in the flow channel, the valve seat, in a closed position of the flap, being in contact with the flap, wherein the spindle penetrates the flap at an angle and openings of the bore each lead to one side of the flap; and a seal arranged In the bore between the flap and the spindle.

### CROSS-REFERENCE TO RELATED APPLICATIONS

This is a U.S. national stags of application Ho. PCT/EP2015/09760, filed on 15 Dec. 2015, which claims priority to the German Application No. 10 2014 226 736.6 filed 19 Dec. 2014, the content of both incorporated herein by reference.

### BACKGROUND OF THE INVENTION

1. Field of the Invention

The invention relates to a valve device for a fuel cell arrangement in a motor vehicle, having a flow channel extending in a housing. A flap is arranged in the flow channel and nerves to close off the flow channel. The flap is fastened on a spindle, the spindle is mounted rotatably in the housing; and in the flow channel there is arranged a valve seat which, in the closed position of the flap, is in contact with the flap, and wherein the spindle penetrates the flap at an angle and the flap has, for this purpose, a bore, the openings of which bore each lead to one side of the flap.

2. Related Art

Valve devices are known. On account of the flowing media, such as, for example, air, the actuating elements have to effectuate a high degree of tightness when the flow channel is closed off. Moreover, these elements should ensure good controllability of the flow cross section of the flow channel and thus of the mass flow of the flowing medium. As a result, such valve devices are of a complex construction and therefore relatively costly. It is known to use solenoid valves as shut-off valves since solenoid valves allow relatively good tightness with corresponding expenditure, but continuous regulation of the flowing medium is not possible. However, the closing-off of the flow channel has high importance, since the permissible leakage rates are 10 to 20 times lower than those in the case of conventional throttle flap adjusters in the intake tract of motor vehicles.

### SUMMARY OF THE INVENTION

An object of the invention is therefore to provide a valve device that allows continuous regulation of the medium in a fuel cell arrangement. The object may be achieved by arranging, in the bore for the spindle, a seal between the flap and the spindle.

It has been found that a transfer flow of the fluid from one side of the flap to the other side of the flap is possible through the bore, even with the spindle inserted, With the arrangement of the seal in the bore, the sole remaining flow path via which a fluid can flow from one side of the flap to the other side of the flap in the flow channel is closed off. In particular in the case of very high demands being placed on the tightness of the valve device, as arise in the case of fuel cell arrangements, a seal arranged in such a manner is advantageous, since the allowed leakage rate therein is 10 to 20 times lower than in the case of conventional throttle flap adjusters in the intake tract of motor vehicles. A further advantage is that the sealing action is not created via the fitting pair of spindle and bore and therefore production is possible with relatively large tolerances and thus at relatively low cost.

For fastening the flap on the spindle, it is advantageous to screw the flap to the spindle with at least one screw. This allows simple fitting of the flap.

The fitting of the seal is facilitated if the seal is arranged relatively close to the opening of the bore through which the spindle enters during the fitting process.

If the flap is additionally screwed to the spindle, the arrangement of the screw bore leads to a further flow path because of the consequently accompanying second opening on one side of the flap. Via this flow path, fluid can flow from one side of the flap to the opposite side of the flap, even if only to a particularly small extent. For most applications, even with high tightness demands, the particularly low mass throughput of a fluid with the abovementioned sealing arrangement is acceptable. If even such low mass throughputs via the second flow path are not acceptable, a further advantageous refinement is for the seal to be arranged between the screw bore and the opening of the bore, which opening leads to that side of the flap that has only one opening. In this way, with the arrangement of only one seal, both flow paths can be reliably sealed off.

In a particularly simple refinement, the seal is a seal arranged radially on the spindle or in the bore for the spindle and which seals off against the respectively opposite component. In the simplest case, the seal is an O-ring.

To ensure a defined seat of the seal, it has proven to be advantageous to arrange the seal in a receptacle, preferably in a groove of the spindle or of the bore.

According to another advantageous refinement, weakening of the spindle or flap components by the groove of the seal is avoided in that the seal is an adhesive bond that connects the flap to the spindle. The advantage of such a seal is that no additional changes to already existing components, such as the spindle and the flap, have to be performed, so that, for the changed conditions of use, even already existing valve devices can be retrofitted without significant expenditure.

In another advantageous refinement, the seal is a weld that connects the flap to the spindle. Compared to an adhesive bond, a weld as the seal has the advantage that the tight connection is created solely by the spindle and flap components and the chemical resistance of the bonding partner does not have to be considered.

In the simplest refinement, the drive of the flap is realized by an electric motor that drives the spindle via a gear mechanism. The gear mechanism makes precise adaptation of the flap movement possible.

### BRIEF DESCRIPTION OF THE DRAWINGS

The invention will be discussed in more detail on the basis of an exemplary embodiment. In the figures:

FIG. 1 shows a valve device according to an embodiment of the invention; and

FIGS. 2 and 3 show the valve device of FIG. 1 in section.

### DETAILED DESCRIPTION OF THE PRESENTLY PREFERRED EMBODIMENTS

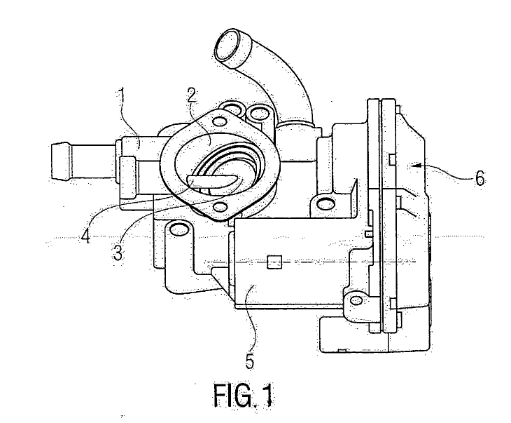

FIG. 1 shows a throttle valve connector having a housing l, having situated in the housing 1 a flow channel 2 in which a disk-shaped flap 3 is arranged. The flap 3 is fixedly connected to a spindle 4 and the spindle 4 is mounted rotatably in the housing The spindle 4 is driven by an electric motor 5 arranged in the housing 1. A gear mechanism 6 is interposed between the spindle 4 and the electric motor 5.

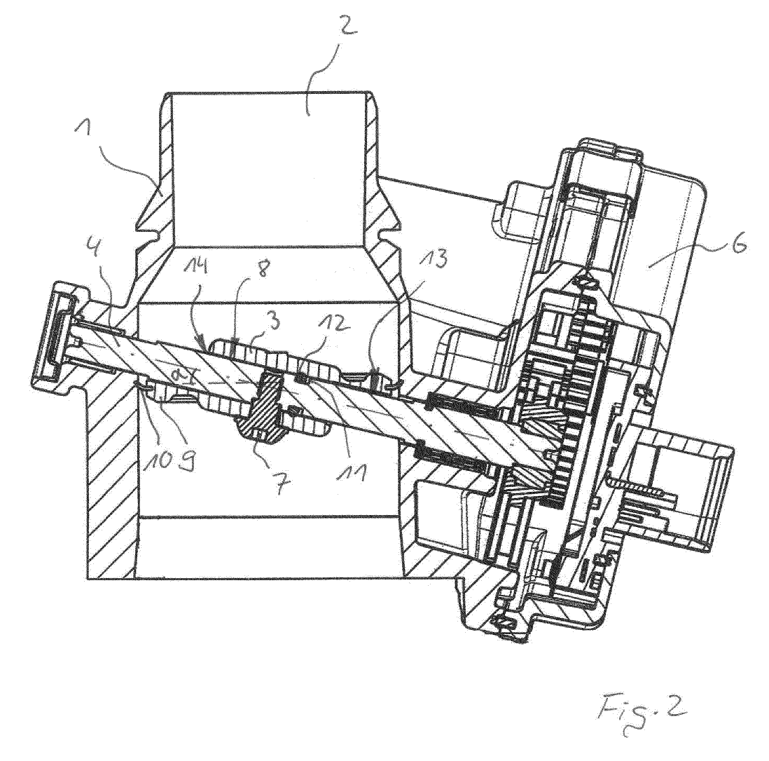

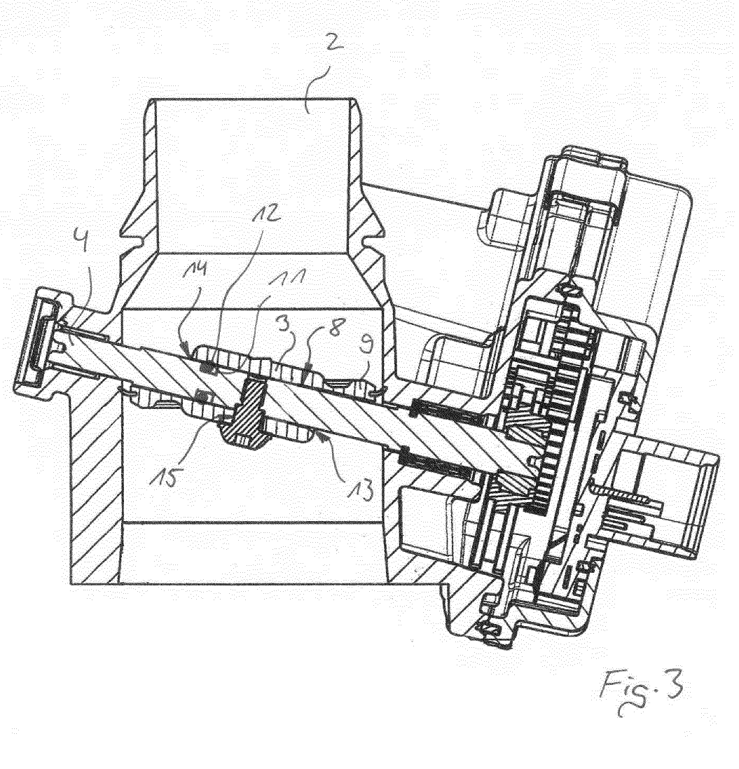

FIG. 2 shows, in section, part of the flow channel 2 according to FIG. 1. The disk-shaped flap 3 is connected rotationally fixedly to the spindle 4 by a schematically illustrated screw connection 7. For holding the spindle 4, the flap 3 has a bore 8 in which the spindle 4 is arranged, such that the spindle 4 penetrates the flap 3 at an angle α. In the illustration shown, the flap 3 closes off the flow channel 2. For sealing off the flow channel 2, a first seal 10 is arranged on the radially circumferential edge 9 of the flap 3. The first seal 10 prevents the flap 3 being flowed around. Besides flowing around the flap 3 on the main flow path, it is also possible for the fluid to flow through the flap 3 through the bore 8. The secondary flow path forms due to tolerances in the fit between the spindle 4 and the flap 3. In order to prevent flow through the flap 3 through the bore 8, the spindle 4 has a radially circumferential groove 11 in which there is arranged a second seal 12 configured as an O-ring. Here, the second seal 12 is arranged so that it is closer to the opening 13 than the opening 14 of the bore 8. Since the spindle 4 is fitted to the flap 3 via the opening 13, relatively simple fitting therefore results. The valve device according to FIG. 3 differs from the valve device according to FIG. 2 in that it can be used for even low leakage rates. In addition to the first secondary flow path, which extends through the entire bore 8, a second secondary flow path forms through the bore 15 of the screw connection, via which path fluid can flow through the flap 3. In the illustration shown, the lower side of the flap thus has two openings 13, 15, whereas the upper side of the flap has only one opening 14. With the arrangement of the O-ring seal 12 in this embodiment being between the screw connection 15 and the opening 14 of the bore 8, wherein the opening 14 is the opening leading to that side of the flap which has only one opening, both secondary flow paths can be sealed off.

Thus, while there have been shown, and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-7. (canceled)

8. A valve device for a fuel ceil arrangement in a motor vehicle, the valve device comprising;
a housing;
a flow channel that extends in the housing;
a spindle mounted rotatably in the housing;
a flap fastened to the spindle, the flap being arranged in the flow channel and configured to close off the flow channel, the flap having a bore via which bore the spindle penetrates the flap;
a drive configured to drive the flap via the spindle;
a valve seat arranged in the flow channel, the valve seat, in a closed position of the flap, being in contact with the flap, wherein the spindle penetrates the flap at an angle and openings of the bore each lead to one side of the flap; and
a seal arranged in the bore between the Hap and the spindle.

9. The valve device as claimed in claim 8, wherein the seal is arranged radially on the spindle or in the bore, the seal being configured to seal off against formation of a flow path between the spindle and the flap.

10. The valve device as claimed in claim 9, wherein the seal is arranged in a receptacle arranged in a groove of the spindle or arranged in a groove of the bore.

11. The valve device as claimed in claim 9, further comprising:
a screw bore configured to fasten the flap on the spindle; and
an opening of the bore in the flap,
wherein the seal is arranged between the screw bore and the opening of the bore in the flap, and wherein the opening leads to a side of the flap having only one opening.

12. The valve device as claimed in claim 9, wherein the seal comprises an adhesive bond configured to connect the flap to the spindle.

13. The valve device as claimed in claim 9, wherein the seal comprises a weld connecting the flap to the spindle.

14. The valve device as claimed in claim 8, wherein the drive comprises an electric motor and a gear mechanism.
